(19) United States
(12) Patent Application Publication
(10) Pub. No.: US 2005/0259527 A1
(43) Pub. Date: Nov. 24, 2005

(54) Optical component triaxial actuator and recording/reproducing apparatus using the same

(75) Inventor: Makoto Nagasato, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/132,252

(22) Filed: May 19, 2005

(30) Foreign Application Priority Data
May 21, 2004 (JP) 2004-151873

(51) Int. Cl. G11B 7/00

(52) U.S. Cl. 369/44.14; 369/44.15; 369/44.22; 369/44.32

(57) ABSTRACT

A first magnetic pole surface having N and S poles neighboring in a focus direction and a second magnetic pole surface having N and S poles neighboring in a tracking direction are formed on the same surface. A focus coil and a radial tilt coil are arranged to cross a magnetic flux formed by the first magnetic pole surface. A tracking coil is arranged to cross a magnetic flux formed by the second magnetic pole surface.

### CROSS-REFERENCE TO RELATED APPLICATIONS

This application is based upon and claims the benefit of priority from prior Japanese Patent Application No. 2004-151873, filed May 21, 2004, the entire contents of which are incorporated herein by reference.

### BACKGROUND OF THE INVENTION

1. Field of the Invention

The present invention relates to an optical component triaxial actuator, which drives an optical component such as objective lens for collecting laser beam onto an optical disk to focus, tracking and radial tilt directions. Moreover, the present invention relates to a recording/reproducing apparatus, which records and reproduces information with respect to an optical disk using the optical component triaxial actuator.

2. Description of the Related Art

As is well known, a technique of recording information (data) at high density has been recently developed. An optical disk having a recording capacity of 4.7 GB (Giga Bytes) in its single-sided one layer has been practically used.

For example, CD (compact disk)-ROM (read only memory), DVD (digital versatile disk)-ROM, DVD-R (recordable), DVD-RW (rewritable), DVD-RAM (random access memory) and HD (high definition)-DVD are given as the optical disk.

In an optical disk drive for recording or reproducing data with respect to this kind of optical disk, a technique of transferring information at high speed has advanced. In order to achieve the foregoing high-speed transfer of information, principally, the optical disk is rotated at speed higher than standard speed. For this reason, the trust of an objective lens actuator must be increased to track an objective lens with respect to the optical disk.

JPN. PAT. APPLN. KOKAI Publication No. 62-94711 discloses an objective lens actuator for tracking an objective lens with respect to an optical disk rotating at high speed. However, the foregoing Publication merely discloses the configuration of driving the objective lens to biaxial directions, that is, focus and tracking directions. For this reason, the objective lens actuator is not suitable for practical use.

On the contrary, JPN. PAT. APPLN. KOKAI Publication No. 2002-208383 discloses an objective lens triaxial actuator. The triaxial actuator can drive an objective lens to triaxial directions, that is, focus, tracking and radial tilt directions, and realize miniaturization and high drive sensitivity.

On the other hand, in an optical disk drive, the thrust of the objective lens actuator is increased to achieve high-speed transfer of information. In addition, higher resonance frequency must be improved in movable member of the objective lens actuator. However, according to the foregoing Publication No. 2002-208383, stiffness is small in the structure of the movable member of the objective lens actuator. For this reason, there is a problem that it is difficult to enhance the higher resonance frequency.

In particular, a report of the performance of the objective lens actuator disclosed in the Publication No. 2002-208383 has been made in the meeting of the optical disk-related worldwide learn society, ISOM/ODS 2002.

ISOM/ODS: joint International Symposium on Optical Memory and Optical Data Storage.

According to the paper reported in Technical Digest of the foregoing ISOM/ODS 2002, it can be seen that the objective lens actuator is not suitable for practical use because higher resonance frequency is low, that is, 20 kHz.

Paper: Junya Aso et al.: ISOM/ODS 2002, pp. 326-328

### BRIEF SUMMARY OF THE INVENTION

According to one aspect of the present invention, there is provided an optical component triaxial actuator, which drive an optical component for collecting laser beam onto an information recording surface of an optical disk to each of focus direction, tracking direction and radial tilt direction, comprising:
a first magnetic pole surface configured so that a magnetic pole having a first magnetism and a magnetic pole having a second magnetism are neighboring in the focus direction;
a second magnetic pole surface configured so that a magnetic pole having a first magnetism and a magnetic pole having a second magnetism are formed on the same surface as the first magnetic pole surface, and neighboring in the tracking direction;
a focus coil arranged to cross a magnetic flux formed by the first magnetic pole surface, and configured to drive the optical component to the focus direction;
a radial tilt coil arranged to cross a magnetic flux formed by the first magnetic pole surface, and configured to drive the optical component to the radial tilt direction; and
a tracking coil arranged to cross a magnetic flux formed by the second magnetic pole surface, and configured to drive the optical component to the tracking direction.

According to another aspect of the present invention, there is provided a recording/reproducing apparatus comprising:
an optical component triaxial actuator driving an optical component for collecting laser beam onto an information recording surface of an optical disk to each of focus direction, tracking direction and radial tilt direction, and including: a first magnetic pole surface configured so that a magnetic pole having a first magnetism and a magnetic pole having a second magnetism are neighboring in the focus direction; a second magnetic pole surface configured so that a magnetic pole having a first magnetism and a magnetic pole having a second magnetism are formed on the same surface as the first magnetic pole surface, and neighboring in the tracking direction; a focus coil arranged to cross a magnetic flux formed by the first magnetic pole surface, and configured to drive the optical component to the focus direction; a radial tilt coil arranged to cross a magnetic flux formed by the first magnetic pole surface, and configured to drive the optical component to the radial tilt direction; and a tracking coil arranged to cross a magnetic flux formed by the second magnetic pole surface, and configured to drive the optical component to the tracking direction;
a recording section configured to record information to the optical disk via the optical component driven to each of focus direction, tracking direction and radial tilt direction by the optical component triaxial actuator; and
a reproducing section configured to reproduce information from the optical disk via the optical component driven to each of focus direction, tracking direction and radial tilt direction by the optical component triaxial actuator.

### BRIEF DESCRIPTION OF THE SEVERAL VIEWS OF THE DRAWING

FIG. 1 is a block diagram to explain the configuration of an optical disk drive according to one embodiment of the present invention;

FIG. 2 is a perspective view to explain the appearance of a triaxial actuator of the embodiment when viewing it from a predetermined angle;

FIG. 3 is a perspective view to explain the appearance of the triaxial actuator of the embodiment when viewing it from another angle;

FIG. 4 is an exploded perspective view to explain the placement of detailed components of the triaxial actuator of the embodiment;

FIG. 5 is a perspective view to explain the magnetic pole of a pair of magnets used for the triaxial actuator of the embodiment;

FIG. 6 is a perspective view to explain the positional relationship between magnets and coils used for the triaxial actuator of the embodiment;

FIG. 7 is a top plan view to explain the positional relationship between magnets and coils used for the triaxial actuator of the embodiment;

FIG. 8 is a side view to explain the positional relationship between magnets and coils used for the triaxial actuator of the embodiment;

FIG. 9 is a perspective view to explain an objective lens retainer used for the triaxial actuator of the embodiment when viewing it from a predetermined angle;

FIG. 10 is a perspective view to explain the objective lens retainer used for the triaxial actuator of the embodiment when viewing it from another angle;

FIG. 11 is a graph to explain actual measured data of frequency characteristic in the focus direction when an experimental triaxial actuator is manufactured in the embodiment;

FIG. 12 is a graph to explain actual measured data of frequency characteristic in the tracking direction when an experimental triaxial actuator is manufactured in the embodiment;

FIG. 13 is a perspective view to explain the placement of suspension wires used for the triaxial actuator of the embodiment; and

FIG. 14 is a side view to explain the placement of suspension wires used for the triaxial actuator of the embodiment.

### DETAILED DESCRIPTION OF THE INVENTION

One embodiment of the present invention will be described below with reference to the accompanying drawings.

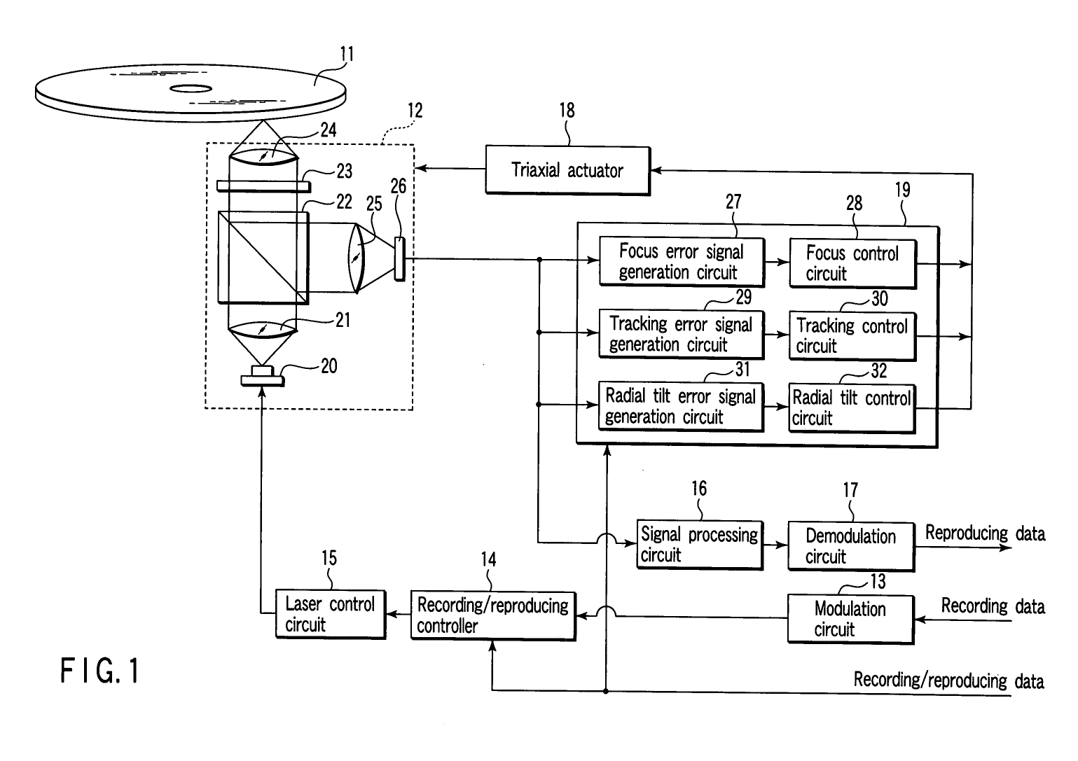

FIG. 1 shows an optical disk drive according to this embodiment. The optical disk drive has a function of recording and reproducing information with respect to optical disk 11 such as CR-R, CD-RW, DVD-R, DVD-RW and DVD-RAM.

The optical disk drive includes optical head 12, modulation circuit 13, recording/reproducing control section 14, laser control circuit 15, signal processing circuit 16, demodulation circuit 17, triaxial actuator 18, triaxial control section 19.

The optical head 12 includes semiconductor laser 20, collimator lens 21, PBS (polarization beam splitter) 22, ¼-wave plate 23, objective lens 24, condenser lens 25 and photo-detector 26.

The triaxial control section 19 includes focus error signal generation circuit 27, focus control circuit 28, tracking error signal generation circuit 29, tracking control circuit 20, radial tilt error signal generation circuit 31, and radial tilt control circuit 32.

The flow of recording information to the optical disk 11 by the optical disk drive will be explained below. The modulation circuit 13 modulates recording information (data symbol) provided from the host into channel bit string based on a predetermined modulation. The channel bit string corresponding to the recording information is inputted to the recording/reproducing control section 14.

The recording/reproducing control section 14 is supplied with a recording/reproducing instruction (in this case, recording instruction) from the host. The control section 14 outputs a control signal to the triaxial actuator 18 to drive the optical head 12 so that light beam is properly collected to a target recording position. The control section 14 further supplies the channel bit string to the laser control circuit 15.

The laser control circuit 15 converts the channel bit string into a laser drive waveform to drive the semiconductor laser 20. In other words, the laser control circuit 15 pulse-drives the semiconductor laser 20. By doing so, the semiconductor laser 20 radiates recording light beam corresponding to a desired bit string.

The recording light beam radiated from the semiconductor laser 20 is shaped into a parallel light via the collimator lens 21, and incident upon the PBS 22, and thereafter, transmits through there. The light beam transmitting through the PBS 22 transmits through the ¼-wave plate 23, and then, is collected to an information recording surface of the optical disk 11 by the objective lens 24.

The recording light beam thus collected is kept on the information recording surface of the optical disk 11 in a state that the best light beam spot is obtained according to the following controls. One is focus control by the focus control circuit 28 and the triaxial actuator 18. Another is tracking control by the tracking control circuit 30 and the triaxial actuator 18. Another is radial tilt control by the radial tilt control circuit and the triaxial actuator 18.

The flow of reproducing information from the optical disk 11 by the optical disk drive will be explained below. The recording/reproducing control section 14 is supplied with a recording/reproducing instruction (in this case, reproducing instruction) from the host. The control section 14 outputs a reproduction control signal to the laser control circuit 15 according to the reproducing instruction from the host.

The laser control circuit 15 drives the semiconductor laser 20 based on the reproduction control signal. By doing so, the semiconductor laser 20 radiates reproducing light beam. The reproducing light beam radiated from the semiconductor laser 20 is shaped into a parallel light via the collimator lens 21, and incident upon the PBS 22, and thereafter, transmits through there. The light beam transmitting through the PBS 22 transmits through the ¼-wave plate 23, and then, is collected to the information recording surface of the optical disk 11 by the objective lens 24.

The reproducing light beam thus collected is kept on the information recording surface of the optical disk 11 in a state that the best light beam spot is obtained according to the following controls. One is focus control by the focus control circuit 28 and the triaxial actuator 18. Another is tracking control by the tracking control circuit 30 and the triaxial actuator 18. Another is radial tilt control by the radial tilt control circuit and the triaxial actuator 18.

The reproducing light beam radiated onto the optical disk 11 is reflected by a reflection film or reflective recording film in the information recording surface. The reflection light transmits through the objective lens 24 in the reverse direction, and then, is again shaped into parallel light. The reflected light beam transmits through the ¼-wave plate 23, and thereafter, is reflected by the PBS 22 having polarization vertical to the incident light.

The light beam reflected by the PBS 22 is shaped into converging rays via the condenser lens, and incident upon the photo-detector 26. The photo-detector 26 is composed of four-divided photo detectors. Luminous flux incident upon the photo-detector 26 is photo-electrically converted into an electric signal, and thereafter, amplified. The amplified signal is equalized and binarized by the signal processing circuit 16, and then, sent to the demodulation circuit 17.

The focus error signal generation circuit 27 generates a focus error signal based on part of the electric signal outputted from the photo-detector 26. Likewise, the tracking error signal generation circuit 29 generates a tracking error signal based on part of the electric signal outputted from the photo-detector 26. Likewise, the radial tilt error signal generation circuit 31 generates a radial tilt error signal based on part of the electric signal outputted from the photo-detector 26.

The focus control circuit 28 controls the triaxial actuator 18 based on the focus error signal to control the focus of a beam spot. The tracking control circuit 30 controls the triaxial actuator 18 based on the tracking error signal to control tracking of the beam spot. The radial tilt control circuit 32 controls the triaxial actuator 18 based on the tracking error signal to control radial tilt of the beam spot.

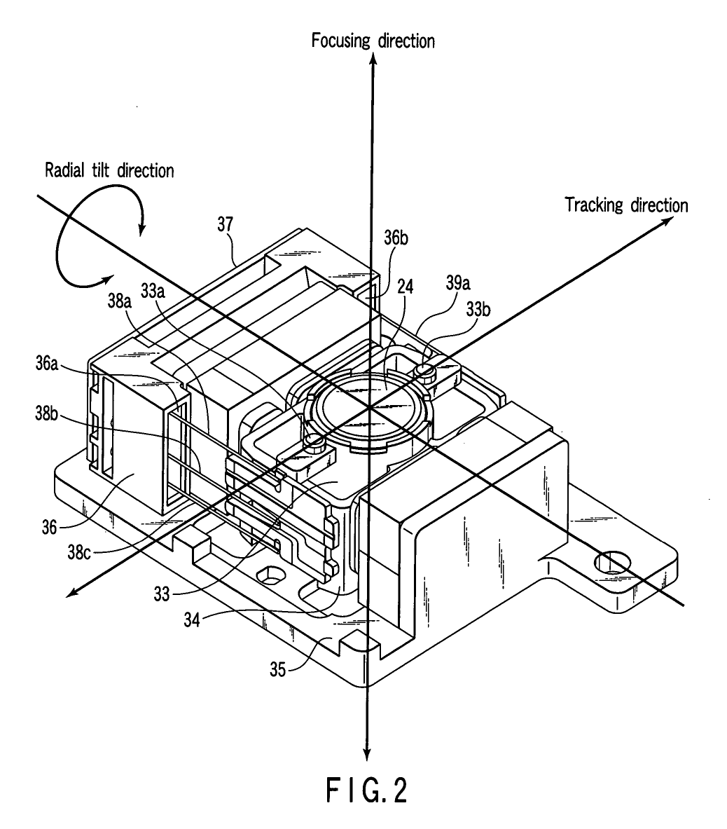

FIG. 2 shows the appearance of the triaxial actuator 18. The triaxial actuator 18 has a movable member 34 including a retainer 33 holding the objective lens 24. The triaxial actuator 18 has a function of driving the movable member 34 independently to triaxial directions, that is, focus, tracking and radial tilt directions with respect to the information recording surface of the optical disk 11. The retainer 33 is formed with protectors 33a and 33b for preventing collision of the optical disk 11 with the objective lens 24.

In FIG. 2, a reference numeral 35 denotes a plat-shaped yoke base. The plat-shaped yoke base 35 is located to become parallel with the information recording surface of the optical disk 11. One end of the yoke base 35 is provided with a damping holder 36.

The damping holder 36 is formed with openings 36a and 36b at its both ends in the tracking direction. The openings 36a and 36b extend to a direction parallel with the yoke base 35 and perpendicular to the tracking direction.

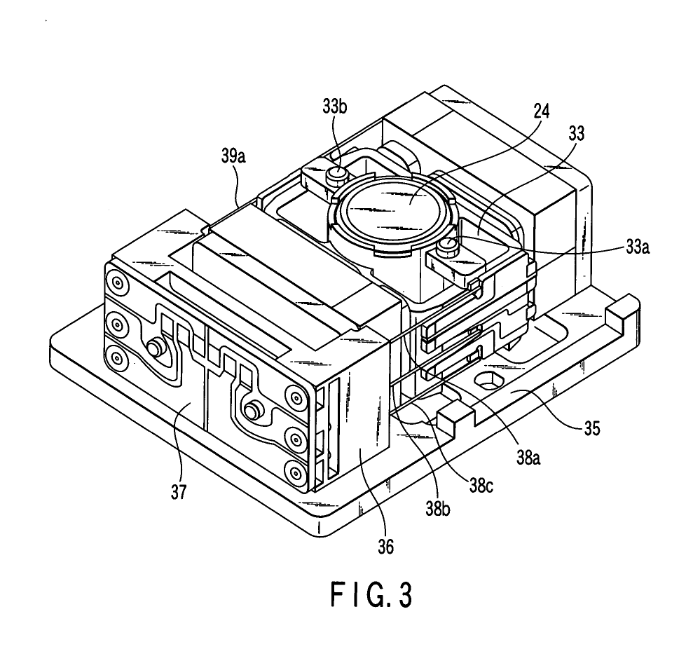

The damping holder 36 is further attached with a stationary circuit board 37 as seen from FIG. 3. The stationary circuit board 37 is connected with each output terminal of focus, tracking and radial tilt control circuits 28, 30 and 32 forming the triaxial control section 19.

The stationary-end circuit board 37 is fixedly attached with one end of elastic linear material, that is, three suspension wires 38a to 38c through the opening 36a of the damping holder 36 in parallel with the focus direction. These suspension wires 38a to 38c are formed of a conductive material, and their other ends extend to approximately the center of the yoke base 35 through the opening 36a of the damping holder 36.

Moreover, the stationary-end circuit board 37 is fixedly attached with one end of three suspension wires 39a to 39c (39b and 39c are not shown in FIG. 2 and FIG. 3) through the opening 36b of the damping holder 36 in parallel with the focus direction. These suspension wires 38a to 38c are formed of a conductive material, and their other ends extend to approximately the center of the yoke base 35 through the opening 36b of the damping holder 36.

The foregoing movable member 34 is supported between the other ends of three suspension wires 38a to 38c and the other ends of three suspension wires 39a to 39c.

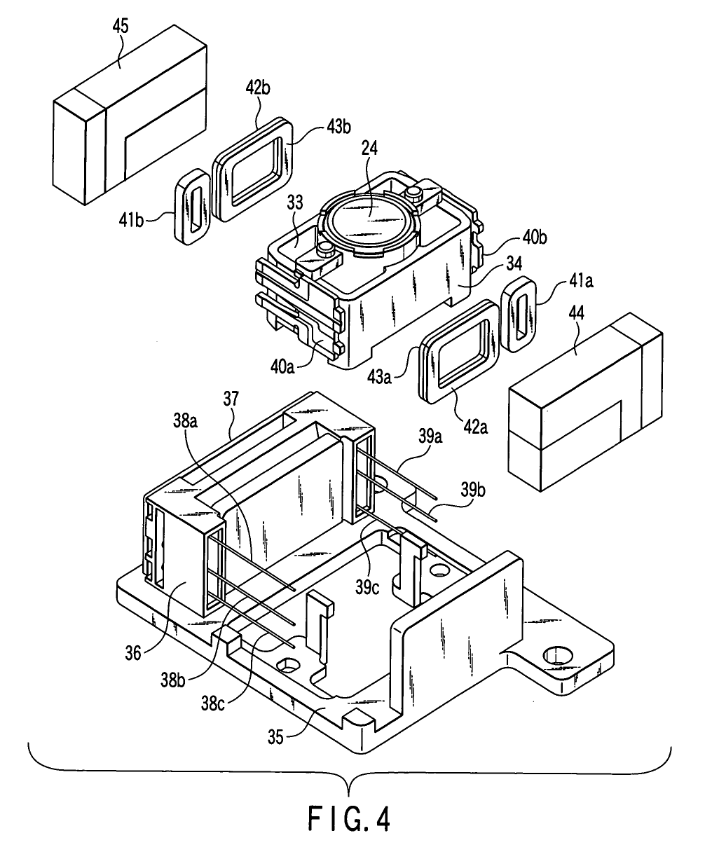

More specifically, the movable member 34 is formed into a substantially rectangular shape as illustrated in FIG. 4. The upper surface of the movable member 34 is attached with the retainer 33 holding the objective lens 24. The movable member 34 is attached with movable-end circuit boards 40a and 40b at its both ends in the tracking direction.

The other ends of three suspension wires 38a to 38c are connected with the movable-end circuit board 40a. On the other hand, the other ends of three suspension wires 39a to 39c are connected with the movable-end circuit board 40b. By doing so, the movable member 34 is elastically supported so that it is movable in the triaxial direction with respect to the yoke base 35.

In this case, the openings 36a and 36b of the damping holder 36 are filled with a viscoelastic material such as silicone (grease?). By doing so, high damping property is given to the foregoing suspension wires 38a to 38c and 39a to 39c.

The movable member 34 is attached with tracking coil 41a, focus coil 42a and radial tilt coil 43a at one end in the direction perpendicular to the tracking direction. In this case, the focus and radial tilt coils 42a and 43a are arranged in a state of being overlapped with each other.

The movable member 34 is further attached with tracking coil 41b, focus coil 42b and radial tilt coil 43b at the other end in the direction perpendicular to the tracking direction. In this case, the focus and radial tilt coils 42b and 43b are arranged in a state of being overlapped with each other.

The foregoing coils 41a to 43a and 41b to 43b are connected to the movable-end circuit boards 40a and 40b. By doing so, the output from the triaxial control section 19 is supplied to these coils 41a to 43a and 41b to 43b via stationary-end circuit board 37, suspension wires 38a to 38c, 39a to 39c, movable-end circuit boards 40a and 40b.

The yoke base 35 is attached with a magnet 44.

In this case, the magnet 44 is fixed to face tracking, focus and radial tilt coils 41a, 42a and 43a of the movable member 34 supported by suspension wires 38a to 38c and 39a to 39c with a predetermined distance.

The yoke base 35 is further attached with a magnet 45. In also case, the magnet 45 is fixed to face tracking, focus and radial tilt coils 41b, 42b and 43b of the movable member 34 supported by suspension wires 38a to 38c and 39a to 39c with a predetermined distance.

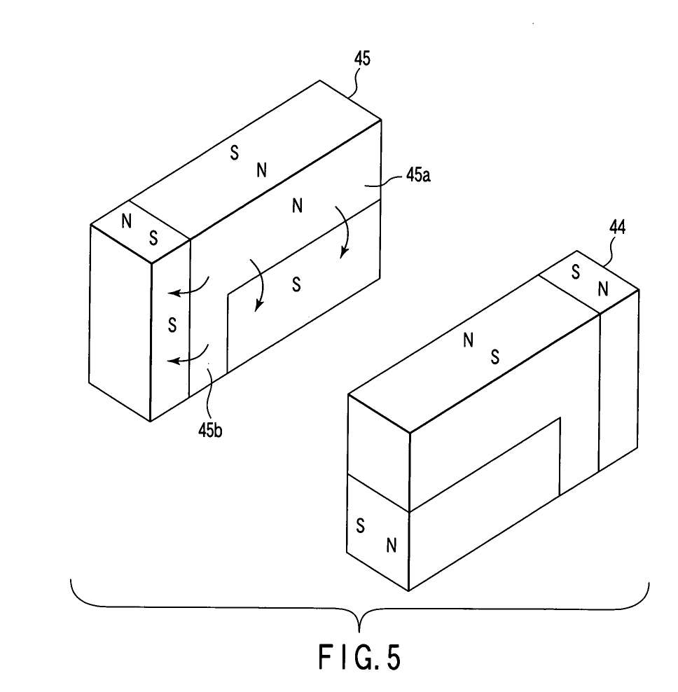

The foregoing magnets 44 and 45 are arranged via the movable member 34. In this case, the magnetic pole on the facing surface is formed as shown in FIG. 5. More specifically, the surface of the magnet 45 facing the magnet 44 is formed with first and second magnetic pole surface parts 45a and 45b. In the first magnetic pole surface part 45a, N and S poles are neighboring in the focus direction; in other words, a magnetic filed is generated in the focus direction. In the second magnetic pole surface part 45b, N and S poles are neighboring in the tracking direction; in other words, a magnetic filed is generated in the tracking direction.

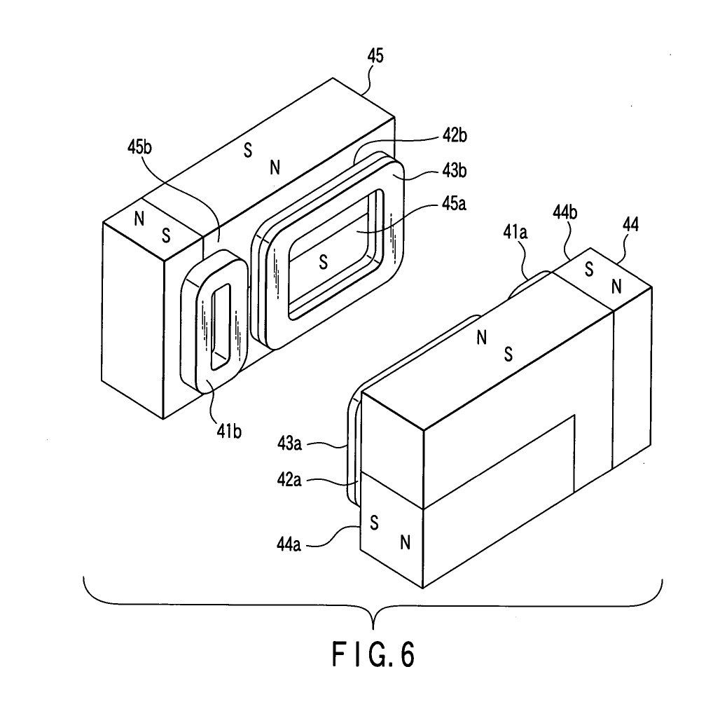

As depicted in FIG. 6, the foregoing focus and radial tile coils 42b and 43b are arranged to cross over both N and S magnetic poles in the first magnetic pole surface part 45a of the magnet 45. Namely, these focus and radial tile coils 42b and 43b are arranged to cross over a magnetic flux formed by the first magnetic pole surface part 45a. The tracking coil 41b is arranged to cross over both N and S magnetic poles in the first magnetic pole surface part 45b of the magnet 45. Namely, the tracking coil 41b is arranged to cross over a magnetic flux formed by the second magnetic pole surface part 45b.

On the contrary, the magnet 44 is formed with first and second magnetic pole surface parts 44a and 44b, which are axially symmetrical to the magnet 45 with respect to the optical axis of the objective lens 24. In the first magnetic pole surface part 44a, N and S poles are neighboring in the focus direction; in other words, a magnetic filed is generated in the focus direction. In the second magnetic pole surface part 44b, N and S poles are neighboring in the tracking direction; in other words, a magnetic filed is generated in the tracking direction.

The foregoing focus and radial tile coils 42a and 43a are arranged to cross over both N and S magnetic poles in the first magnetic pole surface part 44a of the magnet 44. Namely, these focus and radial tile coils 42a and 43a are arranged to cross over a magnetic flux formed by the first magnetic pole surface part 44a. The tracking coil 41a is arranged to cross over both N and S magnetic poles in the first magnetic pole surface part 44b of the magnet 44. Namely, the tracking coil 41a is arranged to cross over a magnetic flux formed by the second magnetic pole surface part 44b. In other words, these coils 41b to 43b and 41a to 43a are arranged to become axially symmetrical with respect to the optical axis of the objective lens 24.

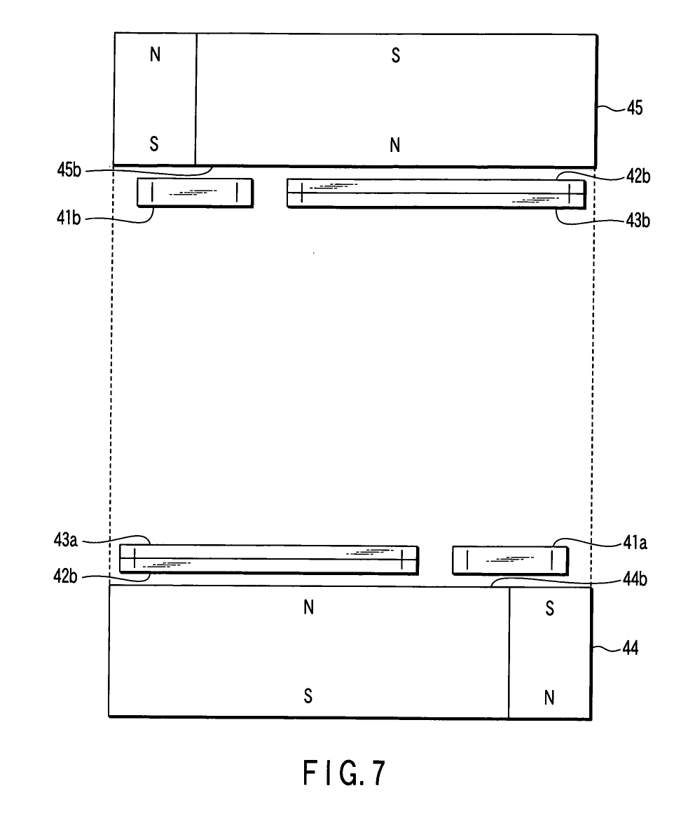

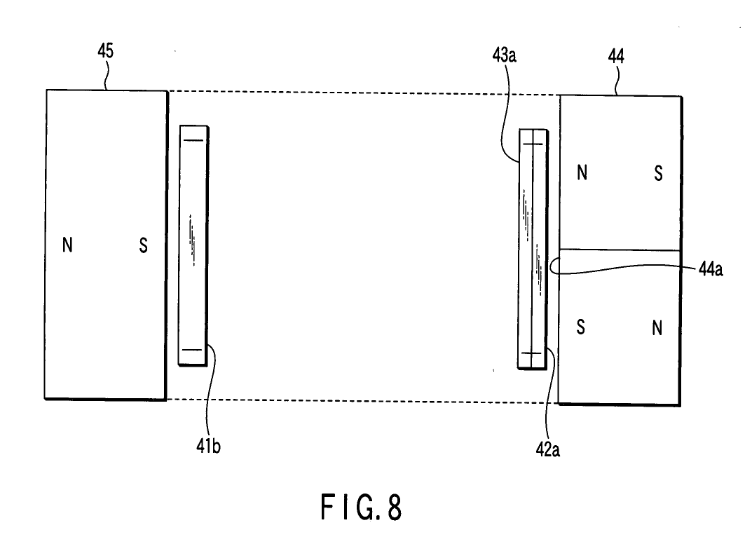

FIG. 7 and FIG. 8 shows the positional relationship between magnet 45, tracking, focus, radial tilt coils 41b, 42b, 43b and magnet 44, tracking, focus, radial tilt coils 41a, 42a, 43a. FIG. 7 shows a state of viewing FIG. 6 from the top (focus direction); on the other hand, FIG. 8 shows a state of viewing FIG. 6 from the side (tracking direction).

As seen from FIG. 7, tracking, focus, radial tilt coils 41b to 43b and 41a to 43a are arranged so that they are not mutually overlapped when viewing them from the radial tile direction perpendicular to the tracking direction.

In the triaxial actuator 18 having the structure described above, the triaxial control section 19 supplies a control signal, that is, current to focus coils 42a and 42b to drive the objective lens 24 to the focus direction. By doing so, the same focus-direction electromagnetic force is applied to both focus coils 42a and 42b. Thus, the movable member 34 is driven to the focus direction by the electromagnetic force, and thereby, the objective lens 24 is driven to the optical axis direction.

Likewise, the triaxial control section 19 supplies a control signal, that is, current to tracking coils 41a and 41b to drive the objective lens 24 to the tracking direction. By doing so, the same tracking-direction electromagnetic force is applied to both focus coils 41a and 41b. Thus, the movable member 34 is driven to the focus direction by the electromagnetic force, and thereby, the objective lens 24 is driven to the optical axis direction.

The following control is carried out in order to rotate the objective lens 24 to the radial tilt direction. For example, a control signal, that is, current is supplied to the radial tilt coil 43b so that positive optical axis direction electromagnetic force is generated. A control signal, that is, current is supplied to the radial tilt coil 43a so that negative optical axis direction electromagnetic force is generated. By doing so, the movable member 34 is rotated to the radial tilt direction, and thereby, the objective lens 24 is rotated to radial tilt direction.

Preferably, each gap between tracking and focus coils 41a, 42a and the magnet 44 and between tracking and focus coils 41b, 42b and the magnet 45 is set smaller. By doing so, the electromagnetic force is effectively generated.

Tracking coils 41a, 41b, focus coils 42a, 42b and radial tilt coils 43a, 43b may be air-core winding coil or printed coil substrate (fine pattern coil).

The foregoing focus coils 42a, 42b and radial tilt coils 43a, 43b have the same shape and dimension, and are arranged in a state of being overlapped with each other. In this case, these focus coils 42a, 42b and radial tilt coils 43a, 43b do not need to have the same shape and dimension, and of course, various changes may be made as the need arises.

According to the structure described above, mutually facing surfaces of the paired magnets 44 and 45 are formed with first and second magnetic pole surface parts 44a, 45a and 44b, 45b, which are symmetrical with respect to the optical axis, respectively. In the first magnetic surface parts 44a and 45a, N and S poles are neighboring in the focus direction. Likewise, in the second first magnetic surface parts 44b and 45b, N and S poles are neighboring in the tracking direction. In this case, focus coils 42a, 42b and radial tilt coils 43a, 43b are arranged to face the first magnetic surface parts 44a and 45a. Likewise, tracking coils 41a and 41b are arranged to face the second first magnetic surface parts 44b and 45b. Thus, the triaxial actuator has a very small size, and the thrust in the triaxial direction is increased; consequently, the triaxial actuator adaptable to practical use is provided.

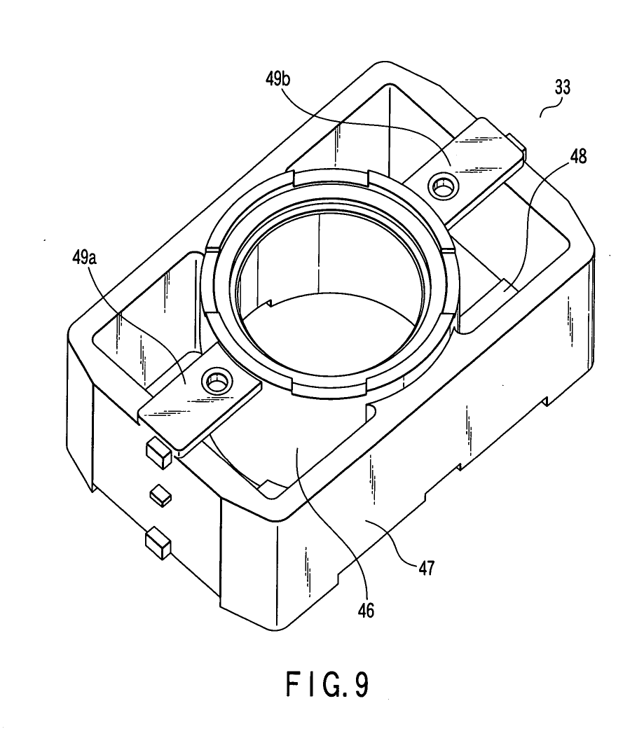

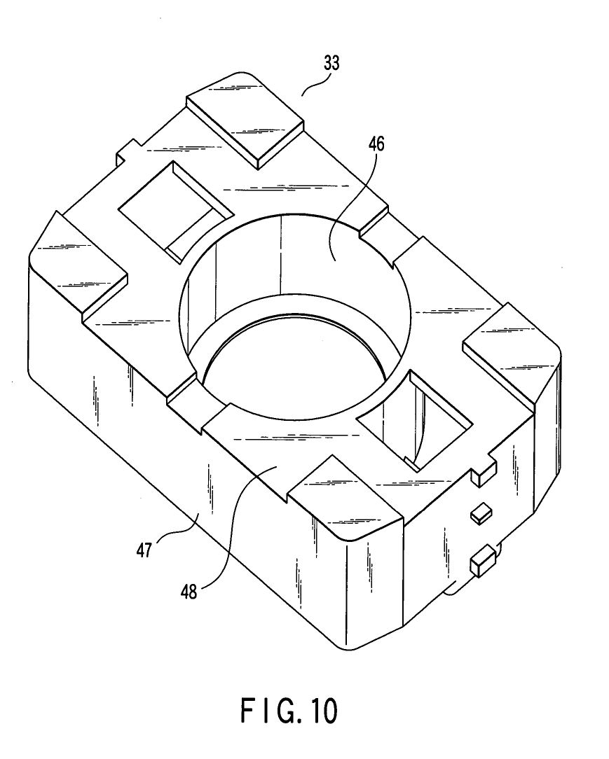

FIG. 9 and FIG. 10 show the structure of the retainer 33 holding the objective lens 24. The retainer 33 is formed of a light and high-stiffness material such as engineering plastics, for example.

The retainer 33 is composed of objective lens holding cylinder 46, rectangular cylinder frame sidewall) 47, bottom plate 48 and a pair of reinforcement bars 49a and 49b. Specifically, the objective lens holding cylinder 46 holds the objective lens 24 at its one end portion. The rectangular cylinder frame 47 is configured to surround the objective lens holding cylinder 46. The bottom plate 48 covers the rectangular cylinder frame 47 on the other side of the holding cylinder 46 excluding the objective lens holding cylinder 46. The pair of reinforcement bars 49a and 49b are arranged to connect the objective lens holding cylinder 46 with the rectangular cylinder frame 47.

According to the foregoing structure of the retainer 33, the rectangular cylinder frame 47 on the other side of the holding cylinder 46 is provided with the bottom plate 48. By doing so, high stiffness is obtained, and the bottom plate functions as a counter weight of the objective lens 24. Therefore, the balance in the center of gravity is improved as the movable member 34, and it is possible to prevent a generation of low-band resonance in tracking frequency characteristics.

In order to improve the stiffness in the tracking direction, the paired reinforcement bars 49a and 49b are arranged to connect the objective lens holding cylinder 46 with the rectangular cylinder frame 47. By doing so, tracking higher resonance frequency is greatly improved.

In order to transfer data at high speed in the optical disk drive, it is essential conditions to increase the thrust of the objective lens actuator, and in addition, to improve higher resonance frequency of the movable member of the objective lens actuator. According to the present invention, the retainer 33 having the foregoing structure is used, and thereby, the higher resonance frequency is largely improved in focus and tracking directions.

Moreover, the retainer 33 may be provided with a recess portion at the vicinity of the optical axis on the side of the bottom plate 48 on the other side of the objective lens holding cylinder 46. The recess portion is used for providing optical components such as diffraction grating optical filter and wave plate for improving the function of the optical head 12.

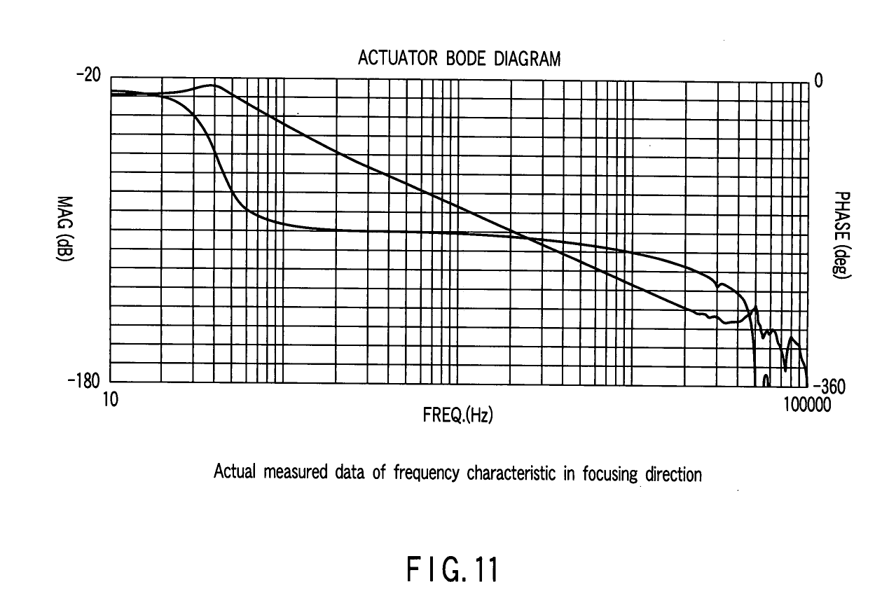

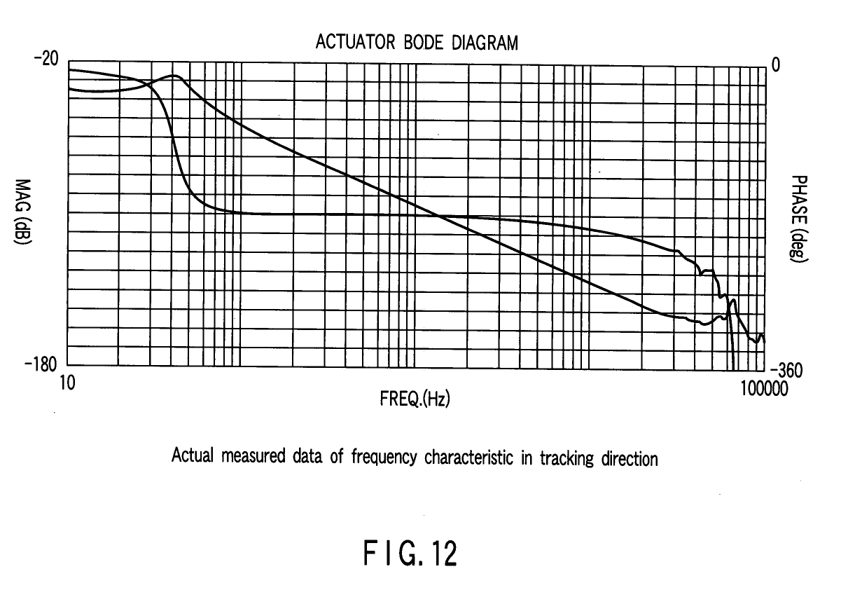

The triaxial actuator 18 using the retainer having the foregoing structure was experimentally manufactured. FIG. 11 and FIG. 12 show actual measured data of the frequency characteristic of the triaxial actuator 18 in focus and tracking directions. As a result, higher resonance frequency of 50 KHz or more is realized in both focus and tracking directions.

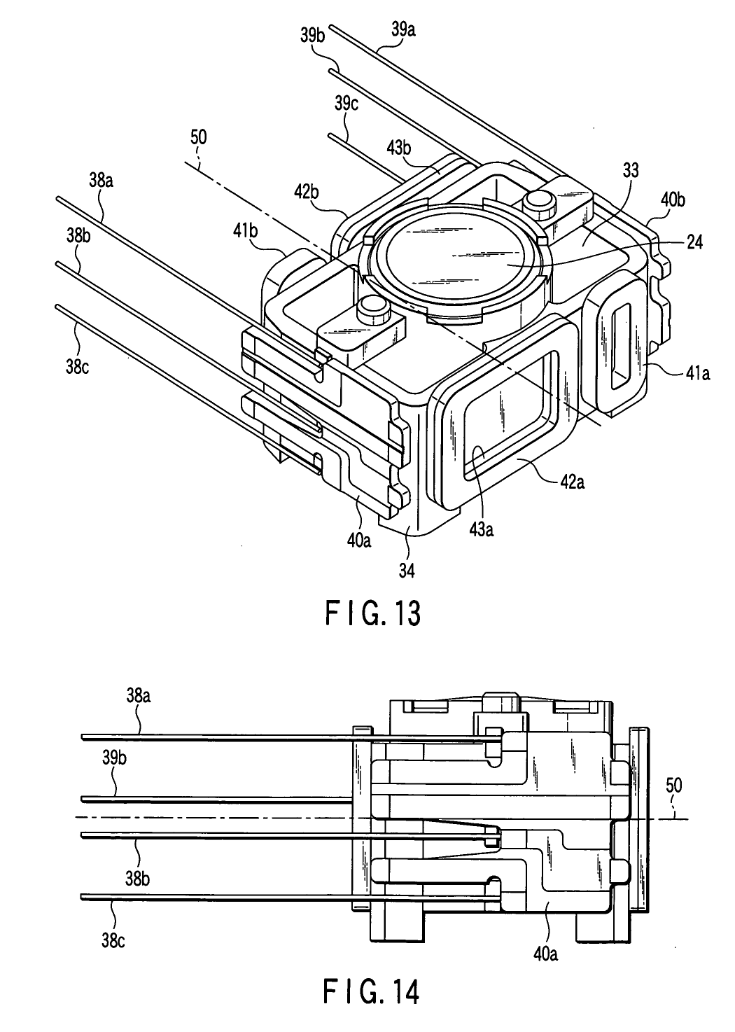

FIG. 13 and FIG. 14 show the placement of support members for supporting the movable member 34, that is, six suspension wires 38a to 38c and 39a to 39c. The suspension wires 38a to 38c and 39a to 39c are arranged every three at each of the positions corresponding to both ends of the tracking direction of the movable member 34.

In this case, the following placement is important. More specifically, three suspension wires 38a to 38c arranged on one side of the movable member 34 are parallel with three suspension wires 39a to 39c arranged on the other side thereof. Moreover, these suspension wires 38a to 38c and 39a to 39c are arranged axially symmetrical with respect to the axis 50 through the center of gravity of the movable member 34. As seen from FIG. 14, the middle suspension wires 38b and 39b are arranged having different height and axially symmetrical with respect to the axis 50 when viewing them from the tracking direction.

The foregoing suspension wires 38a to 38c and 39a to 39c arranged every three at one side of the movable member 34 and the other side thereof. In this case, suspension wires (38a and 39c, 38b and 39b, 38c and 39a) having the axial symmetrical placement relation must be configured having the same material, shape and dimension.

For example, six suspension wires 38a to 38c and 39a to 39c may be all configured having the same material, shape and dimension. In other words, any other form may be made so long as suspension wires (38a and 39c, 38b and 39b, 38c and 39a) having the axial symmetrical placement relation have at least the same spring constant.

For example, three suspension wires 38a to 38c arranged on one side of the movable member 34 are not parallel with three suspension wires 39a to 39c arranged on the other side thereof. Moreover, these suspension wires 38a to 38c and 39a to 39c are not arranged axially symmetrical with respect to the axis 50 through the center of gravity of the movable member 34. In this case, when being moved to the tracking direction, the movable member 34 is largely inclined to the radial tilt direction. As a result, the optical performance of the optical head 12 is largely reduced.

The triaxial actuator 18 can achieve an increase of thrust in the triaxial direction, and the thrust of focus coils 32a, 342b and radial tilt coils 43a, 43b is arbitrarily set by properly changing the thickness of each coil.

The structure of the retainer 33 for the objective lens 24 is optimized to greatly improve the stiffness, and thereby, very higher resonance frequency of 50 kHz or more is realized. Moreover, suspension wires 38a to 38c and 39a to 39c are arranged axially symmetrical, and thereby, it is possible to prevent the inclination of the objective lens 24 when the objective lens 24 moves to the tracking direction.

Therefore, it is possible to realize a high-performance and high-speed-enabled optical disk drive. More specifically, there is provided an optical disk drive, which can transfer data at high speed, and prevent the objective lens 24 from being inclined to the radial tilt direction when the lens moves to the tracking direction.

The present invention is not limited to the foregoing embodiment, and in the working stage of the invention, components are modified and embodied within the scope without departing from the subject matter of the invention. Several components disclosed in the foregoing embodiment are properly combined, and thereby, various inventions are formed. For example, some components may be deleted from all components disclosed in the embodiment. Moreover, components relevant to the embodiment may be properly combined.

1. An optical component triaxial actuator, which drive an optical component for collecting laser beam onto an information recording surface of an optical disk to each of focus direction, tracking direction and radial tilt direction, comprising:
a first magnetic pole surface configured so that a magnetic pole having a first magnetism and a magnetic pole having a second magnetism are neighboring in the focus direction;
a second magnetic pole surface configured so that a magnetic pole having a first magnetism and a magnetic pole having a second magnetism are formed on the same surface as the first magnetic pole surface, and neighboring in the tracking direction;
a focus coil arranged to cross a magnetic flux formed by the first magnetic pole surface, and configured to drive the optical component to the focus direction;
a radial tilt coil arranged to cross a magnetic flux formed by the first magnetic pole surface, and configured to drive the optical component to the radial tilt direction; and
a tracking coil arranged to cross a magnetic flux formed by the second magnetic pole surface, and configured to drive the optical component to the tracking direction.

2. The actuator according to claim 1, wherein the first magnetic pole surface, second magnetic pole surface, focus coil, radial tilt coil and tracking coil make a pair, and are arranged to become axially symmetrical with respect to an optical axis of the optical component.

3. The actuator according to claim 1, further comprising:
a retainer configured to hold the optical component,
the retainer including:
an objective lens holding cylinder configured to hold the objective lens at its one end;
a rectangular cylinder frame configured to surround the objective lens holding cylinder;
a bottom plate configured to cover the rectangular cylinder frame on the other side of the holding cylinder excluding the objective lens holding cylinder;
a pair of reinforcement bars configured to connect the objective lens holding cylinder with the rectangular cylinder frame.

4. The actuator according to claim 3, wherein the retainer is formed of engineering plastic.

5. The actuator according to claim 3, further comprising:
a movable member configured to support the retainer;
a support member configured to movably support the movable member in the focus, tracking and radial tilt directions; and
a drive section configured to drive the movable member in the focus, tracking and radial tilt directions,
the support member comprising several elastic linear materials having a stationary one end and movable other end and configured to support the movable member,
said several elastic linear materials being parallel with each other, and arranged axially symmetrical with respect to an axis through the center of gravity of the movable member.

6. The actuator according to claim 5, wherein said several elastic linear materials are six suspension wires, and both ends of the movable member are each supported by three suspension wires support in the tracking direction.

7. A recording/reproducing apparatus comprising:
an optical component triaxial actuator driving an optical component for collecting laser beam onto an information recording surface of an optical disk to each of focus direction, tracking direction and radial tilt direction, and including: a first magnetic pole surface configured so that a magnetic pole having a first magnetism and a magnetic pole having a second magnetism are neighboring in the focus direction; a second magnetic pole surface configured so that a magnetic pole having a first magnetism and a magnetic pole having a second magnetism are formed on the same surface as the first magnetic pole surface, and neighboring in the tracking direction; a focus coil arranged to cross a magnetic flux formed by the first magnetic pole surface, and configured to drive the optical component to the focus direction; a radial tilt coil arranged to cross a magnetic flux formed by the first magnetic pole surface, and configured to drive the optical component to the radial tilt direction; and a tracking coil arranged to cross a magnetic flux formed by the second magnetic pole surface, and configured to drive the optical component to the tracking direction;
a recording section configured to record information to the optical disk via the optical component driven to each of focus direction, tracking direction and radial tilt direction by the optical component triaxial actuator; and
a reproducing section configured to reproduce information from the optical disk via the optical component driven to each of focus direction, tracking direction and radial tilt direction by the optical component triaxial actuator.

8. The apparatus according to claim 7, wherein the first magnetic pole surface, second magnetic pole surface, focus coil, radial tilt coil and tracking coil make a pair, and are arranged to become axially symmetrical with respect to an optical axis of the optical component.

9. The apparatus according to claim 7, further comprising:
a retainer configured to hold the optical component,
the retainer including:
an objective lens holding cylinder configured to hold the objective lens at its one end;
a rectangular cylinder frame configured to surround the objective lens holding cylinder;
a bottom plate configured to cover the rectangular cylinder frame on the other side of the holding cylinder excluding the objective lens holding cylinder;
a pair of reinforcement bars configured to connect the objective lens holding cylinder with the rectangular cylinder frame.

10. The apparatus according to claim 9, wherein the retainer is formed of engineering plastic.

11. The apparatus according to claim 9, further comprising:
a movable member configured to support the retainer;
a support member configured to movably support the movable member in the focus, tracking and radial tilt directions; and
a drive section configured to drive the movable member in the focus, tracking and radial tilt directions,
the support member comprising several elastic linear materials having a stationary one end and movable other end and configured to support the movable member,
said several elastic linear materials being parallel with each other, and arranged axially symmetrical with respect to an axis through the center of gravity of the movable member.

12. The apparatus according to claim 11, wherein said several elastic linear materials are six suspension wires, and both ends of the movable member are each supported by three suspension wires support in the tracking direction.
